(19) United States
(12) Patent Application Publication
(10) Pub. No.: US 2007/0284170 A1
(43) Pub. Date: Dec. 13, 2007

(54) Retarding control for hydromechanical drive machine

(76) Inventors: Brian D. Kuras, Metamora, IL (US); Thomas M. Sopko, East Peoria, IL (US); Frank A. DeMarco, East Peoria, IL (US); Michael G. Cronin, Peoria, IL (US)

Correspondence Address: Caterpillar Inc.;Intellectual Property Dept., AB 6490, 100 N.E. Adams Street, PEORIA, IL, 61629-6490, US

(21) Appl. No.: 11/451,767

(22) Filed: Jun. 13, 2006

(51) Int. Cl. B60K 25/10

(52) U.S. Cl. 180/165

(57) ABSTRACT

A method of dissipating power in a propelled machine having a hydromechanical transmission includes converting undesired power to retarding power, and driving an engine with at least a portion of the retarding power prior to substantially dissipating power with any other power-dissipating device.

### TECHNICAL FIELD

This invention relates to hydrostatic drive systems for propelled machines, and more particularly to retarding control for propelled machines having a hydromechanical drive.

### BACKGROUND

Retarding performance of a propelled machine relates to the capability of the propelled machine to dissipate undesired power or energy. Such undesired power may include the power of the machine when moving at an undesired speed and/or direction. For example, undesired power of the machine can result from travel down an incline, or exist just after the initiation of a directional shift of the machine from a reverse direction to a forward direction, or vice versa. Conventional propelled machines having mechanical transmissions and drivetrains dissipate portions of undesired power as heat by way of mechanical clutches, torque converters and the engine.

U.S. Pat. No. 5,954,799 to Bernd Dietzel (“the '799 patent”) discloses a propelled vehicle having a process for influencing the drag torque of an electric drive system. The process includes the use of an electric drive system having a reversible generator and two reversible electric motors. The electric motors can act as generators and produce electrical power in response to energy acting to rotate the tires of the machine. The generated electrical power may then be supplied to the generator, which can then act as a motor to drive the internal combustion engine. The driving of the internal combustion engine by the generator at a speed of rotation equal to an idling speed of the engine serves to improve the fuel efficiency of the vehicle by obviating the need to inject fuel into the engine.

The '799 patent is generally directed to maintaining a desired speed of the vehicle, but does not disclose maximizing the possible drag torque of the electric drive system in the instance of complete braking of the vehicle or a complete hierarchy of power dissipating devices. Accordingly, the '799 patent does not provide, for example, a complete retarding strategy for dissipating undesired power in a propelled machine having an electric drive.

The present invention avoids some or all of the aforesaid shortcomings in the prior art.

### SUMMARY OF THE INVENTION

In accordance with one aspect of the invention, a method of dissipating power on a propelled machine having a hydromechanical transmission is provided. The method includes the steps of converting undesired power to retarding power through the hydromechanical transmission and driving an internal combustion engine with at least a portion of the retarding power prior to substantially dissipating power through a hydraulic relief valve by providing at least a portion of the retarding power to the hydraulic relief valve.

According to another aspect of the present invention, a method of dissipating power in a propelled machine having a hydromechanical transmission is provided. The method includes the steps of providing retarding power to an engine, driving the engine with at least a first portion of the retarding power, providing a second portion of the retarding power to at least one of an energy storage component and a hydraulic powered accessory of the propelled machine. The second portion corresponds to retarding power exceeding a predetermined dissipation limit of the engine. Finally, dissipating excess retarding power by an application of at least one brake of the propelled machine.

According to yet another aspect of the present invention, a method of dissipating undesired power in a propelled machine having a hydromechanical transmission is provided. The method includes the steps of driving an engine with the undesired power, providing undesired power to at least one of an energy storage component and a hydraulic powered accessory of the propelled machine, providing undesired power to a hydraulic relief valve after the driving the engine by the undesired power reaches a maximum limit, and applying at least one brake of the propelled machine.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic representation of a hydromechanical drive system for a propelled machine in accordance with an exemplary embodiment of the present disclosure;

FIG. 2 is a flow diagram illustrating an exemplary retarding strategy of the present disclosure; and

FIG. 3 is a flow diagram illustrating another exemplary retarding strategy of the present disclosure.

### DETAILED DESCRIPTION

Reference will now be made in detail to the drawings. Whenever possible, the same reference numbers will be used throughout the drawings to refer to the same or like parts.

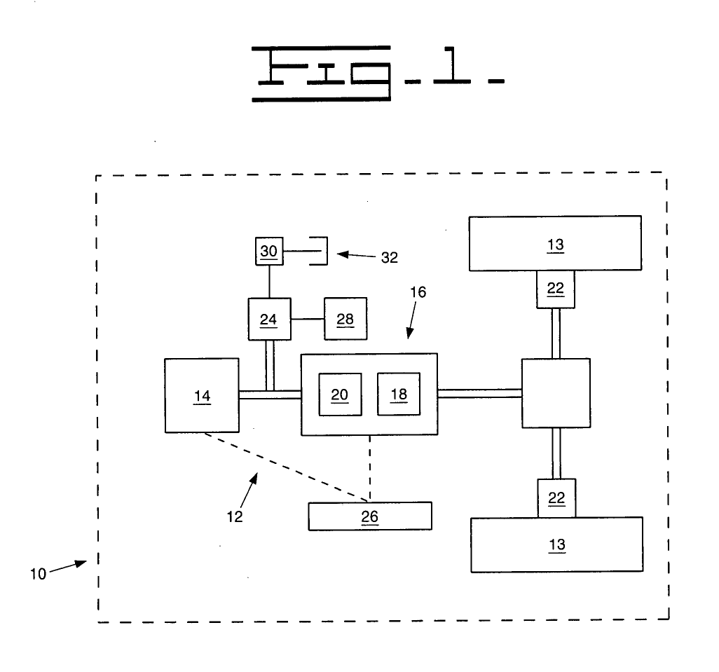

FIG. 1 schematically illustrates a propelled machine 10 having a hydromechanical drive 12 in accordance with an exemplary embodiment of the present disclosure. The hydromechanical drive 12 may be used in any type of machine having wheels or sprockets 13 for propelling the propelled machine 10. For example, the hydromechanical drive 12 may be used on a dozer machine having tracks propelled by sprockets 13 coupled to the hydromechanical drive 12.

As illustrated in FIG. 1, the hydromechanical drive 12 may include an internal combustion engine 14 coupled to provide power to a hydromechanical transmission 16. The hydromechanical transmission 16 may include a hydrostatic system 18 having a pump and motor (not shown) and a mechanical system 20, which may be a planetary type transmission (not shown). Brakes 22 may be coupled to each wheel or sprocket 13.

The internal combustion engine 14 may be of any conventional type and size. For example, internal combustion engine 14 may be a diesel, gasoline, or natural gas driven engine. All such alternative configurations of the internal combustion engine 14 may be generally referred to as engine means.

The hydromechanical transmission 16 may be electromechanical, thereby providing power to the mechanical system from a motor having a source of electric power, such as a battery, for example. The hydromechanical transmission 16 may include appropriate power electronics 26. The power electronics 26 may include, for example, appropriate hardware and software for controlling the operation of the hydromechanical transmission 16, as is known in the art.

The engine 14 may be coupled to drive a number of hydraulic accessories of the propelled machine 10. For example, the internal combustion engine 14 may be mechanically coupled to drive one or more hydraulic pumps 24, one or more water pumps (not shown), a fan (not shown), and/or an alternator (not shown), an accumulator 28, or other energy storage device, and implement and steering pumps. The accumulator 28 may be configured to receive excess hydraulic fluid during a retarding moment. The accumulator 28 may be triggered into operation by upstroking or destroking the pump 24 or a separate valve (not shown) to open flow therein.

The brakes 22 may be of any conventional type having variable control. For example, brakes 22 may be mechanically or hydraulically actuated by an appropriate mechanical or fluid control system, or may be in the form of a hydraulic retarder. All such alternative configuration of the brakes 22 may be generally referred to as brake means. During application of the brakes 22, power of the machine is dissipated from the brakes 22 in the form of released heat. Accordingly, the brakes 22 may require an appropriate cooling system. The brakes 22 may be the primary braking system for the propelled machine 10, or may be a supplemental system for use solely or primarily in connection with the retarding strategy of the present disclosure.

During propulsion of the propelled machine 10 by the hydromechanical drive 12, the internal combustion engine 14 combusts fuel to drive the hydromechanical transmission 16. The hydromechanical transmission 16, in turn, provides power to drive the wheels or sprockets 13.

The propelled machine 10 is also capable of retarding or dissipating undesired power/energy. Such undesired power may be in the form of power added to the propelled machine 10 based on its travel down an incline, or in the form of movement of the propelled machine 10 in a slower desired speed than actual. The retarding process associated with these two categories of undesired power is generally referred to as downhill retarding and directional shift retarding, respectively. It is understood that the terms “energy” and “power” are referred to herein interchangeably, in that power is merely the time derivative of energy.

A retarding process dissipates the undesired power throughout the propelled machine 10. In particular, the undesired power may be dissipated through four major categories of components of the propelled machine 10; namely the internal combustion engine 14, hydraulic accessories, such as the accumulator 28, the relief valve 30, and the brakes 22. These four categories of components may include all of the alternative configurations detailed above in connection with the individual components, and may generally be referred to as a first, second, third, and fourth means for dissipating undesired power.

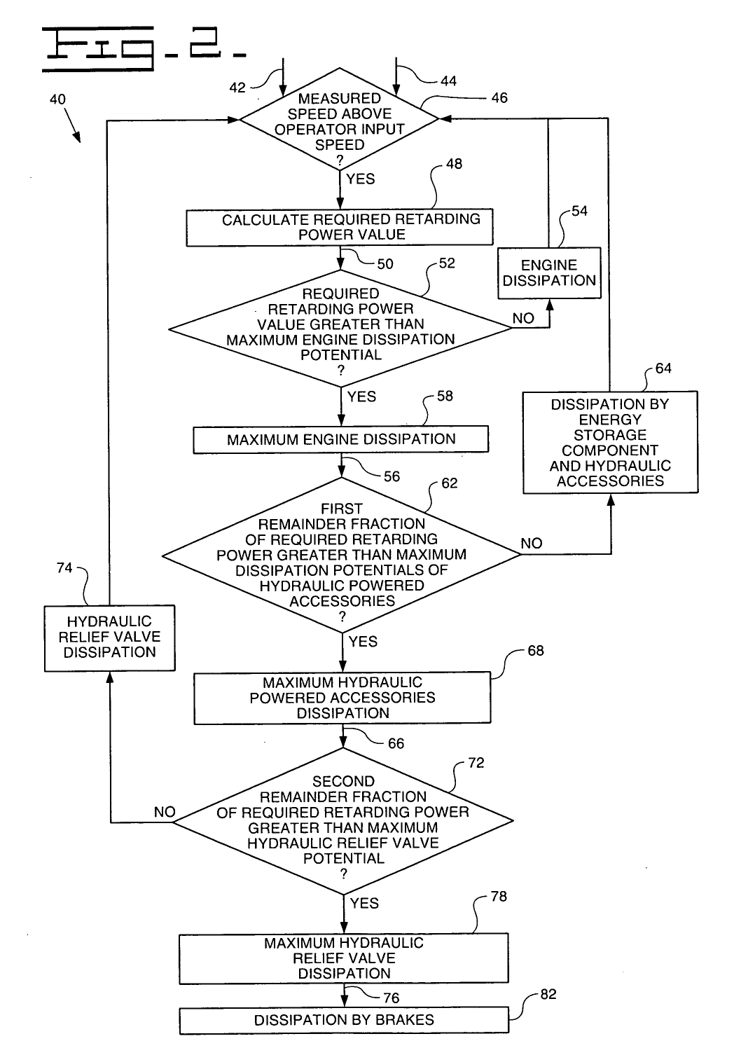

During the retarding process undesired power is received from the wheels or sprockets 15 and applied to the hydromechanical transmission 16. Subsequently, in accordance with the retarding strategy to be discussed below in connection with FIG. 2, the power is distributed to the internal combustion engine 14, hydraulic accessories, relief valve 30, and the brakes 22.

For example, all or a portion of the power may be distributed to the hydromechanical transmission 16, which would now operate to drive the internal combustion engine 14. Upon driving the internal combustion engine 14, the natural engine friction dissipates the undesired power through natural engine friction, exhaust restrictors, compression release devices, and driven accessories of the engine.

Other portions of the retarding power may be supplied to the pump 24 and through the relief valve 30 to sump 32. In doing so, the power supplied to the pump 24 through the relief valve 30 dissipates in the form of heat through a hydraulic fluid cooler (not shown). It is understood that the cooler may require an appropriate air or liquid cooling system to keep the cooler within its temperature limits. In addition the power could be distributed through the pump 24 to the accumulator 28.

As indicated above, the brakes 22 may also dissipate undesired power in the propelled machine 10. This is achieved by activating the brakes 22, which in turn dissipate the undesired power in the propelled machine in the form of heating of the components of the brake 34. Appropriate conventional brake cooling systems may be included to maintain the brakes 22 below undesired temperatures.

### INDUSTRIAL APPLICABILITY

FIG. 2 illustrates a retarding strategy 40 in accordance with an exemplary embodiment of the present disclosure. The retarding strategy 40 according to the present disclosure provides for substantially complete utilization of the propelled machine 10 in dissipating undesired power. As noted, power is dissipated through the internal combustion engine 14, hydraulic accessories, relief valves 30, and brakes 22. Accordingly, greater fuel efficiency is achieved by way of reducing the need for fuel in the internal combustion engine 14 when the engine 14 is being driven by the hydromechanical transmission 16. Further, spreading the power dissipation among the several components of the propelled machine 10 increases the life of each of the power dissipating devices, including the brakes 22.

As shown, an operator speed input 42 determines a desired speed of the propelled machine 10. The desired speed may be set by the operator by any conventional input device, for example, a foot pedal or hand control lever. The operator speed input 42 may include maintaining a particular positive speed of the propelled machine 10, decelerating to zero speed, or decelerating to zero speed and accelerating to positive speed in a direction opposite the movement of the propelled machine 10 (i.e., a directional shift from forward to reverse, or visa versa). The operator speed input 42 is then compared to a measured speed 44 of the propelled machine 10. The measured speed 44 may be obtained by any conventional manner, for example by measuring the rotational speed of shafts connected to the wheels or sprockets 13.

The comparison of the operator speed input 42 with the measured speed 44 takes place at a speed comparison box 46. If the measured speed 44 of the propelled machine 10 is sufficiently close to or less than the operator speed input 42, no retarding of the propelled machine 10 is necessary and an appropriate pause is initiated before again comparing the operator speed input 42 to the measured speed 44. If the measured speed 44 is greater than the operator speed input 42, then retarding is appropriate to dissipate the undesired power associated with the additional speed. If the operator input 42 is simply a torque command, then box 46 can be skipped.

Box 48 of FIG. 2 represents the calculation step of determining the amount of undesired power that needs to be dissipated in order to reduce the speed of the propelled machine 10 to the operator speed input value 42. This value for the undesired power will be hereinafter referred to as a required retarding power value 50, and may be calculated by, inter alia, any appropriate microprocessor using conventional techniques.

Once the required retarding power valve 50 is determined, the retarding strategy 40 determines the best way to dissipate the retarding power throughout the propelled device 10. The retarding strategy 40 includes a hierarchy of devices used to dissipate the retarding power. The hierarchy identifies the internal combustion engine 14 as the first dissipating device, then the accumulator 28, then the hydraulic relief valve 30, and finally the brakes 22 (See FIG. 1). It is noted, however, that the hierarchy identified herein is only one embodiment and that other hierarchies may be used. For example, in certain situations it may be advantageous to dissipate the retarding power first to the accumulator 28 and subsequently to the engine 14.

The internal combustion engine 14 provides for dissipation of the retarding power up to that achieved when the speed limit of the internal combustion engine 14 is reached. Accordingly, the internal combustion engine 14 includes a maximum dissipating potential associated with its operation at its speed limit. Box 52 compares the required retarding power value 50 to the maximum dissipating potential of the internal combustion engine 14. If the maximum dissipating potential of the internal combustion engine 14 is greater than the required retarding power value 50, hydromechanical transmission 16 is controlled as described above to drive the internal combustion engine 14 and dissipate all of the retarding power. This step is identified with box 54. The retarding strategy 40 continuously goes back to comparing the operator speed input 42 to the measured speed 44 of the propelled device 10 in a predefined microprocessor execution timer.

If the required retarding power value 50 exceeds the maximum dissipating potential of the internal combustion engine 14, then the internal combustion engine 14 is used to dissipate the retarding power to its maximum potential (box 58 of FIG. 2), and a first remainder fraction 56 of the retarding power is provided to at least one of the hydraulic accessories, the next dissipation device in the hierarchy of the retarding strategy 40.

Similar to the internal combustion engine 14, the hydraulic accessories include maximum dissipation potentials. Accordingly, box 62 compares the first remainder fraction 56 to the maximum dissipating potential of the hydraulic accessories. If the maximum dissipating potentials of the hydraulic accessories are greater than the first remainder fraction 56, then the hydromechanical transmission 16 is controlled as described above to provide power to the hydraulic accessories to dissipate the first remainder fraction 56. This step is identified with box 64.

If the first remainder fraction 56 exceeds the maximum dissipating potentials of the hydraulic accessories, then the hydraulic accessories are used to dissipate the first remainder fraction 56 to their maximum potential (box 68 of FIG. 2), and a second remainder fraction 66 of the retarding power is provided to the hydraulic relief valve 30, the next device in the hierarchy of the retarding strategy 40.

As with the other power dissipating devices, the hydraulic relief valve 30 includes a maximum dissipation potential. This maximum dissipation potential may be associated with, for example, the temperature limits of the components making up the relief valve 30, the temperature limits of the fluid, or the cooling ability of the cooling device for cooling the hydraulic fluid. Accordingly, box 72 compares the second remainder fraction 66 to the maximum dissipating potential of the hydraulic relief valve 30. If the maximum dissipating potential of the hydraulic relief valve 30 is greater than the second remainder fraction 66, then the hydromechanical transmission 16 and power electronics 26 are controlled as described above to control the hydraulic relief valve 30 to dissipate all of the second remainder fraction 66. This step is identified with box 74 in FIG. 2.

If the second remainder fraction 66 exceeds the maximum dissipating potential of the hydraulic relief valve 30, then the hydraulic relief valve 30 is used to dissipate the second remainder fraction 66 to its maximum potential (box 78 of FIG. 2), and a third remainder fraction 76 of the retarding power is absorbed by the brakes 22, the next dissipation device in the hierarchy of the retarding strategy 40.

The brakes 22 completely dissipate the third remainder fraction 76, thus dissipating all of the required retarding power 50. This process is identified in box 82.

It is understood that the retarding strategy 40 is driven by the power electronics 26. The power electronics 26 may be of any conventional design having hardware and software configured to perform the calculations and send and receive appropriate signals to perform the retarding strategy 40. The power electronics 26 may include one or more controller units, and may be configured solely to perform the retarding strategy 40, or to perform the retarding strategy 40 and other processes of the propelled machine 10. The numerous various alternatives for the power electronics 26 are generally referred to as controller means.

Additionally, it is understood that the maximum dissipating potential for the dissipating devices 14, 22, 28, and 30 may be fixed or variable values. For example, the maximum dissipating potential any of the dissipating devices may be continuously calculated by the controller and, for example, lowered based on the environmental temperature surrounding the propulsion machine 10.

Additionally, the control strategy 40 of FIG. 2 may be modified to (1) omit the use of the hydraulic accessories as a dissipating device, (2) use only one of the hydraulic accessories as a dissipating device, or (3) use more than one of the hydraulic accessories as dissipating devices, but not at the same time.

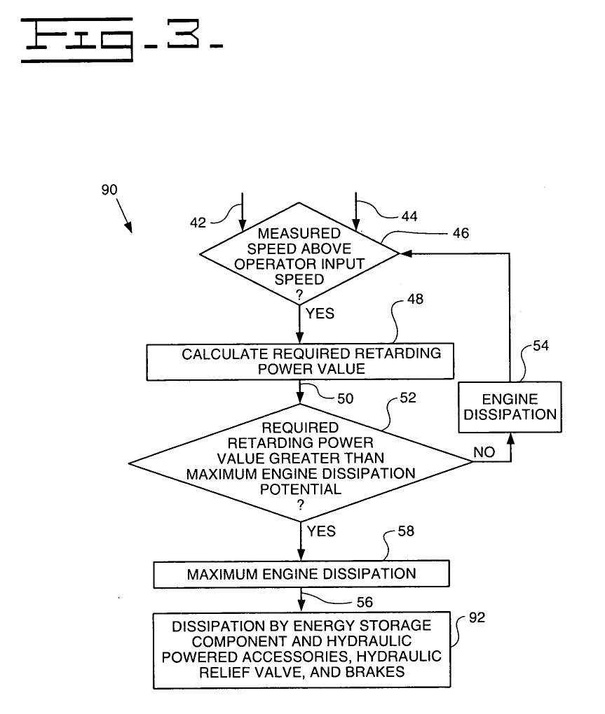

FIG. 3 illustrates another exemplary embodiment of the present disclosure. FIG. 3 includes a retarding strategy 90 similar to the retarding strategy 40 of FIG. 2, except that dissipation by the engine 14, the hydraulic accessories, hydraulic relief valve 30, and brakes 22 are provided substantially simultaneously (box 92 of FIG. 3).

It is noted that numerous other retarding strategies may be used in accordance with the present disclosure. For example, a retarding strategy may include dissipating power by the hydraulic accessories prior to dissipation by the internal combustion engine 14.

Other embodiments of the invention will be apparent to those skilled in the art from consideration of the specification and practice of the embodiments of the invention disclosed herein. It is intended that the specification and examples be considered as exemplary only, with a true scope of the invention being indicated by the following claims.

What is claimed is:

1. A method of dissipating power on a propelled machine having a hydromechanical transmission, comprising:
converting undesired power to retarding power through the hydromechanical transmission; and
driving an internal combustion engine with at least a portion of the retarding power prior to substantially dissipating power through a hydraulic relief valve by providing at least a portion of the retarding power to the hydraulic relief valve.

2. The method of dissipating power according to claim 1, wherein the driving of the internal combustion engine includes driving the engine to a predetermined limit.

3. The method of dissipating power according to claim 2, wherein the predetermined limit corresponds to a speed limit of the internal combustion engine.

4. The method of dissipating power according to claim 1, further including providing another portion of the retarding power to at least one of an energy storage component and an electric powered accessory of the propelled machine.

5. The method of dissipating power according to claim 4, further including dissipating undesired power by an application of at least one brake of the propelled machine.

6. The method of dissipating power according to claim 4, further including providing another portion of the retarding power to a hydraulic relief valve.

7. The method of dissipating power according to claim 6, wherein the providing of the another portion of the retarding power to the hydraulic relief valve includes providing the retarding power to a predetermined limit.

8. The method of dissipating power according to claim 7, wherein the predetermined limit corresponds to a temperature limit of the fluid.

9. The method of dissipating power according to claim 6, further including dissipating retarding power by an application of at least one brake of the propelled machine.

10. The method of dissipating power according to claim 1, further including simultaneously providing another portion of the retarding power to at least one of an energy storage component, a hydraulic powered accessory of the propelled machine, and a hydraulic relief valve, and dissipating undesired power by an application of at least one brake of the propelled machine.

11. A method of dissipating power in a propelled machine having a hydromechanical transmission, comprising:
providing retarding power to an engine;
driving the engine with at least a first portion of the retarding power;
providing a second portion of the retarding power to at least one of an energy storage component and a hydraulic powered accessory of the propelled machine, the second portion corresponding to retarding power exceeding a predetermined dissipation limit of the engine; and
dissipating excess retarding power by an application of at least one brake of the propelled machine.

12. The method of dissipating power according to claim 11, wherein the predetermined dissipation limit corresponds to a speed limit of the engine.

13. The method of dissipating power according to claim 11, further including providing the second portion of the undesired power to both the energy storage component and the hydraulic powered accessory of the propelled machine.

14. The method of dissipating power according to claim 11, further including providing a third portion of the retarding power to a hydraulic relief valve.

15. The method of dissipating power according to claim 14, wherein the providing of the third portion of the retarding power to the hydraulic relief valve includes providing retarding power to a predetermined limit.

16. The method of dissipating power according to claim 15, wherein the predetermined limit corresponds to a temperature limit of the fluid.

17. The method of dissipating power according to claim 11, wherein the dissipation of undesired power by an application of at least one brake of the propelled machine occurs substantially simultaneously with said providing of a second portion of the retarding power to at least one of an energy storage component and a hydraulic powered accessory of the propelled machine.

18. A method of dissipating undesired power in a propelled machine having a hydromechanical transmission, comprising:
driving an engine with the undesired power;
providing undesired power to at least one of an energy storage component and a hydraulic powered accessory of the propelled machine;
providing undesired power to a hydraulic relief valve after the driving the engine by the undesired power reaches a maximum limit; and
applying at least one brake of the propelled machine.

19. The method of dissipating undesired power according to claim 18, further including providing undesired power to both an energy storage component and a hydraulic powered accessory of the propelled machine.

20. The method of dissipating undesired power according to claim 18, wherein the driving of the internal combustion engine includes sending the undesired power to a hydromechanical transmission for driving the internal combustion engine.
